(19) United States
(12) Patent Application Publication
(10) Pub. No.: US 2019/0077687 A1
(43) Pub. Date: Mar. 14, 2019

(54) MODULAR METHOD AND WASTEWATER TREATMENT ARRANGEMENT FOR EFFICIENT CLEANING OF WASTEWATER

(71) Applicant: HOCHWALD FOODS GMBH, 54424 Thalfang (DE)

(72) Inventors: FALK GÖBEL, Radeburg (DE); THOMAS WUTTKE, Glashütte (DE)

(73) Assignee: HOCHWALD FOODS GMBH, 54424 Thalfang (DE)

(21) Appl. No.: 16/085,134

(22) PCT Filed: Mar. 14, 2017
(86) PCT No.: PCT/DE2017/100204

§ 371 Date: Sep. 14, 2018

(30) Foreign Application Priority Data
Mar. 18, 2016 (DE) 10 2016 105 071.7

(51) Int. Cl. C02F 9/00; C02F 1/469

(52) U.S. Cl. CPC C02F 9/00; C02F 1/006; C02F 1/4693

(57) ABSTRACT

A wastewater treatment arrangement for efficiently cleaning variously polluted partial streams of wastewater, in particular of industrial effluents, includes the following components: an electrodialysis unit; an accidental-damage reservoir, a buffer tank, wherein the buffer tank is designed such that it can be reached by partial streams of some of the wastewater indirectly by way of the electrodialysis unit and/or directly, and wherein the buffer tank is designed such that it can be reached by the partial streams of wastewater indirectly by way of the accidental-damage reservoir and/or directly, and wherein downstream of the buffer tank, a first flotation tank, an anaerobic reactor and an SBR unit are arranged in series before the outflow.

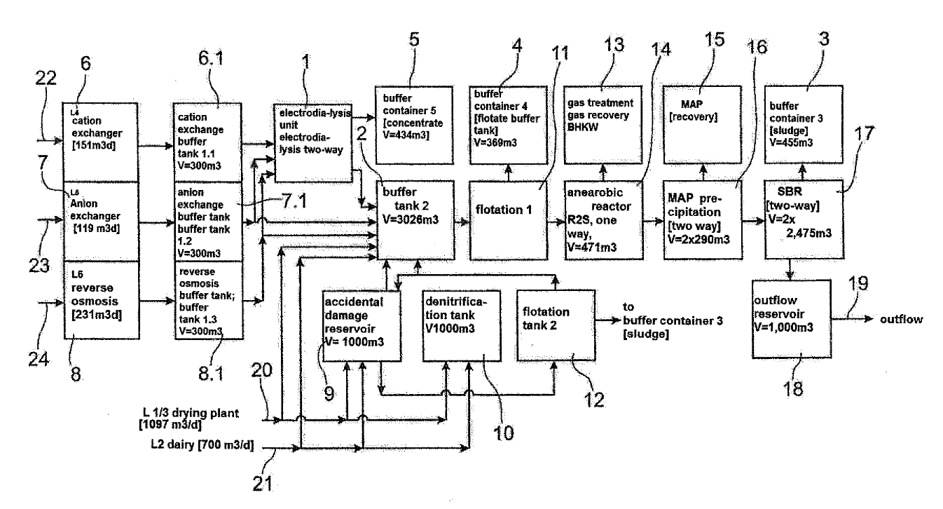

The invention relates to a wastewater treatment arrangement and a method for the efficient purification of differently polluted wastewater streams, in particular of industrial wastewater.

In the industrial sector, often large amounts of wastewater with a chemical composition that differs fundamentally from that of municipal wastewater have to be treated. The production wastewater is often highly contaminated with organic compounds, salts or even toxic ingredients or characterized by fluctuating pH values. Depending on the course of production, these can occur intermittently and then lead to considerable difficulties in wastewater treatment, in particular in the biological stages.

Revisions to the wastewater legislation have in recent years led to tightening of the officially defined discharge limit values. This not infrequently significantly increases the effort for wastewater treatment, so sometimes the cost of the entire process must be called into question.

In the field of municipal wastewater, biological processes are mostly used, such as the biological phosphate elimination, nitrification, denitrification, which are occasionally combined with a chemical phosphate precipitation.

Due to the complex composition of industrial wastewater, these classic process steps are usually not sufficient to achieve the required limits and target values. Therefore, additional processes will be required.

DE 10 2008 050 349 B4 describes a cleaning method where the wastewater is first supplied to mixing and equalizing tanks in order to equalize the various wastewater streams. Subsequently, the wastewater is subjected to anaerobic purification, wherein organic carbon (C) compounds are metabolized to methane and carbon dioxide. The remaining phosphate (P) and nitrogen (N) compounds are partially precipitated in the subsequent purification step as magnesium ammonium phosphate, also referred to as MAP. Since this precipitation is only possible within a narrow pH range, the pH must be adjusted. This is not accomplished by using the generally customary dosage of bases or acids, but instead, carbon dioxide is stripped from the wastewater after leaving the anaerobic stage. Since the ammonium-ammonia equilibrium is pH-dependent, this stripping makes it possible to adjust the molar ratios magnesium:ammonium:phosphate. These purification stages essentially represent a pre-purification. For further purification of the wastewater, aerobic purification processes follow, which in the example are carried out as SBR technology with or without additional phosphate precipitation.

DD 294 003 A5 describes the precipitation of MAP from industrial wastewater. For this purpose, magnesium chloride and/or magnesium oxide and phosphoric acid are added to the wastewater in metered quantities to adjust the appropriate ion ratio. Seeding with MAP seed crystals is disclosed as an essential feature of the invention, which facilitates the crystallization process.

A wastewater treatment plant for wastewater with colloidal water ingredients is disclosed in DE 10 2013 110 303 A1. Here, a combination process of flocculation and filtration is claimed. The water constituents are flocculated and the flakes are removed from the wastewater by a filtration step. The filtrate is thereafter subjected to flotation, which can be performed both as dissolved air flotation with additives or as electroflotation.

DE 10 2013 103 468 A1 also describes the purification of wastewater having a fluctuating electrical conductivity by way of electroflotation.

DE 10 2009 036 080 A1 describes another method for the removing organic pollutants. The wastewater is hereby first concentrated. This results in a reduced amount of wastewater. Subsequently, the concentrate is fed to a filtration device, or a reverse osmosis, and then treated further by electrodialysis. Since all ingredients are still present in the concentrate, however, a rapid degradation of the membranes used should be expected.

DE 43 14 521 describes a process for the purification of organically contaminated industrial wastewaters by using a combination of hydrogen peroxide H₂O₂ and iron-II Fe(II) or iron-III Fe(III), commonly known as Fenton reagent. The organic compounds which are difficult to break down are thereby oxidized.

DE 38 11591 A1 describes a process for the treatment of highly polluted waters from the remediation of contaminated sites. The water is provided with a surfactant, which requires correct adjustment of the pH value. Subsequently, the water is subjected to an activated sludge process in at least two successive reaction spaces. For slightly contaminated wastewater, the harmful substances in the water can be concentrated beforehand by reverse osmosis. It is also disclosed to use an upstream anaerobic stage, to which the excess of activated sludge can be returned. The process can also be combined with chemical purification steps. The goal is here to break down the emulsions with the employed surfactants. However, this method has the disadvantage that surfactants must be critically assessed from the perspective of environmental protection.

DE 20 2008 011 162 U1 describes a device for cleaning highly contaminated wastewaters, consisting of an upstream anaerobic fixed-bed filter with a downstream electro-flocculation cell. With this arrangement, organic compounds are first broken down anaerobically. The released phosphorus compounds are flocculated with the aid of an electric field. In this way, chemical precipitants are conserved; however, electro-flocculation requires a very large amount of energy, which is disadvantageous in view of the ever-increasing energy prices.

U.S. Pat. No. 5,514,282 describes a process for cleaning wastewater from the food industry. The wastewater is first homogenized in a tank. Thereafter, it is passed through a sieve where coarse matter is removed. This is followed by a flotation stage in which fine particulate matter is flocculated. The flakes are separated by filters of different pore sizes. The permeate is discharged. This arrangement is suitable for separating particulate water constituents. Dissolved substances and ions are only insufficiently detected and thus reach the receiving vessel together with the discharged permeate. For large wastewater streams, the filtration devices must have a correspondingly large size, which can result in high membrane and energy costs.

KR 10 10 30 787 B1 describes an arrangement for the purification of dyeing effluents, wherein a tank for neutralization, a storage tank, a reaction tank for the aerobic treatment, a coagulation tank and a sedimentation tank are successively traversed. In this arrangement, chemical and biological processes are combined. Dyeing effluents often contain dyeing compounds which are difficult to biodegrade and precipitate without complex pretreatment. Disadvantageously, not all types of dyeing effluents can be effectively cleaned with this arrangement.

On the other hand, KR 10 2006 100 698 A describes a method for the treatment of leakage water originating from the storage of food industry waste. These waters are first subjected to a solid/liquid separation by way of sedimentation or flotation. Subsequently, after pH adjustment, the water is fed to an anaerobic reactor where organic carbon compounds are broken down. This reduces the chemical oxygen demand COD and the biological oxygen demand BSD5 in the wastewater. In a subsequent aerobic process, ammonium ions are nitrified. Substances that cannot be broken down, such as phosphates and drifting activated sludge particles, are ultimately removed by coagulation and/or flotation.

The listed process wastewater streams are either collected in large tanks and homogenized, or the water constituents are concentrated with expensive filtration process, so that ultimately smaller volumes need to be treated.

The subsequent purification steps in the process then always treat the entire wastewater stream. This is particularly disadvantageous when several partial wastewater streams with widely differing wastewater compositions are produced.

The object of the invention is to develop an arrangement and a method which makes it possible to efficiently clean differently polluted wastewater.

The object is attained by an arrangement and a method having the features of the independent claims. Further embodiments are recited in the dependent claims.

The object is in particular attained by a wastewater treatment system for efficient purification of differently polluted wastewater streams which is characterized by the following components:
an electrodialysis unit
an accidental-damage reservoir,
a buffer tank, wherein
   the buffer tank is constructed to be accessible by wastewater streams indirectly via the electrodialysis unit and/or directly, and that
the buffer tank is constructed to be accessible by the wastewater streams indirectly via the accidental-damage reservoir and/or directly, and that
downstream of the buffer tank, a first flotation tank, an anaerobic reactor and an SBR unit are arranged in series before the outflow.

Preferably, a denitrification tank with a downstream second flotation tank is arranged in parallel with the accidental-damage reservoir, wherein the second flotation tank is connected to the accidental-damage reservoir and/or the buffer tank.

Advantageously, a MAP precipitation unit with a MAP magnesium ammonium phosphate recovery is arranged between the anaerobic reactor and the SBR unit.

Advantageously, a concentrate buffer tank is arranged downstream of the electrodialysis unit and/or a flotate buffer tank is arranged downstream of the first flotation tank and/or a gas treatment, gas recovery, cogeneration unit is arranged downstream of the anaerobic reactor.

The MAP precipitation unit and/or the SBR unit are preferably designed bidirectional for alternating operation of the units for a quasi-continuous operation.

Advantageously, a sludge buffer tank and/or an outflow tank are arranged after the SBR unit for the outflow for the clear water.

The outflow tank is preferably dimensioned such that in normal operation of the wastewater treatment arrangement, the plant is filled only to 50%.

A return pump line into the accidental-damage reservoir is arranged between the outflow reservoir in the event of an accident.

The object of the invention is further attained by a modular method for the efficient cleaning of differently polluted wastewater streams in a wastewater treatment system, which is characterized in that the individual wastewater streams are measured separately and that the wastewater streams are treated separately in a modular fashion as partial streams and are subsequently combined commensurate with their properties and then further treated.

Preferably, the method is further developed in that depending on the properties of the partial wastewater stream

a) an electrodialysis is performed to reduce the chloride load by ⅓ and the potassium load by ⅔ compared to the initial value for only a single partial wastewater stream,
b) a flotation of undissolved substances takes place,
c) an anaerobic wastewater treatment is performed for the production of biogas as valuable material from a salt-rich substrate,
d) a MAP precipitation is carried out to produce magnesium ammonium phosphate as a valuable substance, and that
e) an aerobic wastewater treatment is carried out with the SBR process with further P-elimination in a salt-rich substrate.

Preferably, the treated wastewater stream is filtered before the outflow.

Also advantageous is an exhaust air treatment and desulfurization of the biogas produced during anaerobic wastewater treatment.

Particularly advantageously, a dissolved air flotation is provided in process step b). Alternatively, under appropriate boundary conditions, it is also possible to use electroflotation or similar methods.

According to a further advantageous embodiment of the method, depending on measured phosphorus concentrations, additional phosphorus compounds are eliminated through simultaneous precipitation.

The task is conceptionally solved as follows:

It has been found that industrial wastewater with a complex composition can be treated selectively and cost-effectively with the arrangement and procedure described below, as a result of which the subsequent purification steps corresponding to the prior art are significantly alleviated or can be dimensioned smaller. In total, this leads to a higher level of safety in wastewater treatment with simultaneous cost savings.

According to an advantageous embodiment of the invention, the wastewater produced in the production process is first measured at the site where the wastewater originates. Wastewater streams of similar composition are, for example, combined in intermediate tanks. Subsequently, wastewater contaminated with inorganic substances, wastewater with high inorganic contamination, such as CIP water, which is frequently contaminated with monovalent ions, water contaminated to a normal extent with organic substances and water heavily contaminated with organic substances, e.g. a product with extremely high oxygen consumption that is dislodged/leaked in an accident, is fed to the industrial wastewater treatment plant in separate lines.

The effluents with high inorganic contamination are first fed to electrodialysis in the industrial wastewater treatment plant in order to remove from the wastewater monovalent ions that usually cannot be chemically precipitated. The wastewater, from which a large portion of the interfering ions has now been removed, can now be fed directly to a biological purification stage without causing the salt and the associated high osmotic pressure to adversely affect the metabolic activity of the microorganisms.

The wastewater which is only slightly polluted with inorganic substances, also called inorganic, may optionally also be fed directly to a biological treatment stage after temporary storage in a tank.

The wastewater stream with normal organic contamination is fed to a separate storage tank, from which the downstream purification stages of the industrial wastewater treatment plant are continuously fed.

A sewage stream with high organic contamination, which only occurs in the event of an accident, is pumped into a tank that is generously sized in relation to the event of an accident. This tank is also connected, in addition to a circulating flow, with the outflow reservoir, which homogenizes the purified wastewater prior to its introduction into the receiving water. In case of failure of cleaning stages, the outflow reservoir can thus additionally function as an accidental-damage reservoir. From this accidental-damage reservoir the wastewater is fed load-controlled to the downstream purification stage, so as not to overload this stage.

Wastewater with high nitrate concentrations is in turn fed to an additional tank where it is denitrified. To prevent the active biomass from being flushed out with the wastewater stream, this denitrification tank is provided with a flotation device. The biomass, is thereby separated from the wastewater and returned to the denitrification process. The denitrification tank and the associated flotation form an internal closed loop.

All storage tanks are equipped with a device for circulating the volume of water, such as pumps or stirrers, to prevent sedimentation of particulate wastewater contents.

The tank for the upstream nitrification is additionally equipped with a gassing device for air or oxygen. This is necessary for the preservation of the activated sludge, since the effluents to be treated here are introduced discontinuously, i.e. times without supply of a substrate must be bridged.

All tanks are equipped with an exhaust air treatment device. In addition, the tank for the upstream denitrification is connected via a line to the aerobic purification stage, so that activated sludge, i.e. active biomass, can optionally be supplied, since high load spikes of wastewater ingredients often require a large amount of active biomass for cleaning. With this inoculation, the required amount of active microorganisms can be provided much faster than by culturing in the tank itself.

The basic concept of the invention is that individual wastewater streams are pretreated variably and cost-effectively depending on their composition.

Due to the separate detection of the individual and differently polluted material streams, it is possible to discharge highly contaminated fractions of the total wastewater whose treatment has been shown to be very complex and costly. Thus, only smaller volumes need to be cleaned with special methods, such as electrodialysis, which is reflected in the reduced space requirements for the structures, as well as lower costs for tank construction, consumables and energy usage.

The modular structure and an intelligent interconnection of the individual tanks make it possible to temporarily store the produced wastewater during a fault in the operation, in the production or in case of accidental damage and to recycle or, optionally, dispose of the produced wastewater commensurate with the substances in the water. The system developed for wastewater treatment thus also operates as an accidental-damage system. An additional, an appropriately sized accidental-damage tank is therefore no longer necessary. An accidental-damage system for wastewater treatment plants will continue to gain in importance in the future if the receiving waters are to consistently achieve and comply with the quality criteria required in stricter statutory requirements.

The arrangement of a denitrification stage as a wastewater pretreatment step has the advantage that spikes in the nitrate concentration in industrial wastewater, which occur quite frequently in the food industry during the purification processes, can be microbially broken down and do not adversely affect other biological purification steps. Thus, the anaerobic stage can be constructed to be smaller and be operated more safely, since toxic nitrate/nitrite loads are avoided before feeding the fermenter. This anaerobic process step need not be redundant, because one of the downstream stages of the process, the SBR aerobic system, was initially designed to be larger, with the possibility of an additional chemical precipitation, and is optionally also able to provide a higher cleaning performance during maintenance work on the fermenter.

In addition, in the case of extremely nitrogen-contaminated wastewaters, the upstream denitrification reduces the overall nitrogen load and thus sets more favorable ion ratios for MAP precipitation. It is thus no longer necessary to additionally meter phosphoric acid.

Further details, features and advantages of embodiments of the invention will become apparent from the following description of exemplary embodiments with reference to the accompanying drawing.

According to an exemplary embodiment of the invention, an industrial wastewater treatment plant in operation is described, with which 2300 m³/d of production wastewater of a drying plant, which is used to produce demineralized dry whey, is treated for direct discharger quality. Based on the required cleaning capacity for the load contained in the wastewater, this plant corresponds to a wastewater treatment plant of size class 5 according to the Wastewater Ordinance AbwV, which corresponds to more than 100,000 population equivalents.

The production wastewater of the drying plant to be treated, the partial wastewater stream 20, is characterized by high salt loads, high nutrient contents and high organic loads. Depending on the processing step, water of different composition is produced:

approx. 600 m³/d less polluted wastewater 24 from the rinsing processes during demineralization,
approx. 500 m³/d of highly polluted wastewater 20 from demineralization processes,
approx. 500 m³/d predominantly mineral-contaminated wastewater 22, 23 (vapors, CIP waters from the cleaning and rinsing steps),
approx. 700 m³/d dairy effluents 21 with high organic load.

Sanitary and street effluents are collected separately and fed in the aforedescribed case to a municipal sewage treatment plant. Thus, for example, all of the sludge produced on the industrial wastewater treatment plant can be assigned to the food industry based on its origin, which considerably facilitates later recovery.

The production effluents are fed to the industrial wastewater treatment plant in separate lines 20, 21, 22, 23, 24, which can be fed to a total of six tanks 6.1, 7.1, 8.1, 2, 9, 10.

All wastewater streams 22, which are highly contaminated with mostly inorganic substances and originate from the regeneration of the cation exchanger of the drying plant, are temporarily stored in a tank 6.1 and fed therefrom first to an electrodialysis unit 1.

The water 23 originating from the anion exchanger of the production plant is temporarily stored in tank 7.1 and fed therefrom to the electrodialysis unit. The water 24 originating from the backwashing operations of the reverse osmosis unit 8 of the drying plant is temporarily stored in tank 8.1 and fed therefrom to electrodialysis. Optionally, the partial wastewater stream 24 can also be fed directly from the buffer tank 8.1 of the reverse osmosis unit to the buffer tank 2, provided the composition is suitable. Alternatively, this partial wastewater stream 24 is fed to the electrodialysis unit 1 to regulate the pH value.

The wastewater from the cheese dairy, the inlet 21, is also fed to the independent buffer tank 2, from which the wastewater is directly fed load-controlled to a first flotation tank 11.

Highly contaminated product wastewaters originating from accidents are intercepted in the accidental-damage reservoir 9, from where they are pumped load-controlled into the buffer tank 2. This ensures that load spikes do not unnecessarily burden the biological treatment stages.

An outflow reservoir 18, which serves to ensure the Q24 before introducing the purified wastewater via the outflow 19 into the receiving water, communicates with the accidental-damage reservoir 9 via an unillustrated pipe. This interconnection allows back-pumping and temporarily storing of insufficiently purified wastewater fractions, for example, when sludge is discharged in the event of a technical malfunction at one of the SBR plants, and thus serves directly to protect water bodies from pollution. The outflow reservoir 18 is dimensioned so as to be filled in normal operation of the system to only 50%, leaving additional reserves in the event of an accident.

Effluents with very high nitrate concentrations are fed directly to another separate denitrification tank 10 for protection of the subsequent anaerobic stage. The denitrification tank 10 is used as a small separate denitrification stage located upstream of the actual wastewater purification. The thus denitrified wastewater is fed into the buffer tank 2 via a second flotation tank 12. The denitrification tank 10 is connected to the flotation tank 12 for the purpose of separating the activated sludge required for denitrification and retaining the same in the system. This second flotation tank 12 is to be regarded as one unit with the denitrification tank and provided in the overall arrangement in addition to the first flotation tank 11.

A particular advantage of the arrangement and the method is that the illustrated separate measurement of the individual wastewater streams allows a further targeted and cost-saving treatment.

According to a preferred embodiment, the method steps are as follows:

a) electrodialysis (reduction of the chloride load by ⅓ and the potassium load by ⅔ compared to the initial value)—only for a partial wastewater stream,
b) flotation of undissolved substances,
c) anaerobic wastewater treatment (generation of biogas as a valuable material from a salt-rich substrate),
d) MAP precipitation (production of magnesium ammonium phosphate as a valuable material),
e) aerobic wastewater treatment in SBR reactors (further P-elimination in a salt-rich substrate),
f) wastewater filtration (can be operated optionally).

In addition, exhaust air treatment as well as the required desulphurization of the biogas produced during anaerobic wastewater treatment are carried out.

The partial streams of the inflows 22, 23, 24, which contain predominantly high concentrations of inorganic salts, are fed to the electrodialysis unit 1, wherein the ions are concentrated by way of monovalent membranes and discharged into the concentrate buffer tank 5.

Since the inorganic highly polluted material streams 22, 23, 24 are already detected separately in the drying plant, this process step can be optimized for cost and energy savings. Contamination of the wastewater to be treated by the electrodialysis unit with organic substances from other material streams would cause blocking of the membranes and thus to higher operating costs.

Thereafter, the wastewater in the buffer tank 2, which is now deconcentrated from salts, is then combined with the other wastewaters 20 from the drying plant contaminated with low salt concentrations and wastewater 21 of the cheese dairy contaminated with low salt concentrations and, not shown, fed directly to the SBR unit 17 for further aerobic treatment.

The drying plant efluents from the feed of the drying plant 20, which are heavily contaminated with organic compounds such as whey protein and undissolved substances, are introduced directly into the buffer tank 2 and fed therefrom load-controlled to the first flotation tank 11.

The flotation in the first flotation tank 11 is designed as dissolved air flotation. Aided by flocculants, a portion of the COD is removed in this purification stage. The flotate is fed to the flotation buffer 4 and thereafter to sludge recovery.

The water discharged from the first flotation tank 11 is fed to an anaerobic reactor 14. In this anaerobic reactor, most of the COD is broken down and converted into biogas. In the described industrial wastewater treatment plant, an R2S reactor was used which operates on the basis of granulated biomass. However, any other anaerobic technology that works with bacteria retention in the fermenter can be used.

Systems with immobilized biomass are known to be less sensitive to concentration fluctuations. In addition, sufficient active biomass is always present in the system, so that short residence times can be realized even with a low dry-matter content. Wastewater has significantly lower dry-matter content than conventional biogas substrates. In addition, only small amounts of increased biomass in the form of excess sludge are produced in anaerobic processes.

The resulting fermentation residue is supplied for use in agriculture.

The biogas is desulphurized with alkaline gas scrubbers. Alternatively, however, other types of desulfurization, for example, biological desulfurization, can be used. In this case, the H₂S contained in the biogas is converted to sodium sulfide or sodium hydrogen sulfide and brought into the aqueous phase. After drying and subsequent purification via activated carbon, the purified gas is then converted into electricity in a cogeneration power plant, whereby the produced electrical energy is used internally for the industrial wastewater treatment plant. These process steps are summarized in the FIGURE with the gas treatment, gas utilization cogeneration power plant 13. Thus, as an added benefit, dependence on the electricity provider is reduced.

After leaving the anaerobic reactor 14, the R2S reactor, the wastewater is fed to a redundantly configured magnesium ammonium phosphate precipitation stage, the MAP precipitation unit 16.

Since all effluents originate from the food industry, the precipitated magnesium ammonium phosphate is very pure and can be marketed as a valuable material in what is referred to as MAP magnesium ammonium phosphate utilization 15. The resulting revenues reduce the total costs incurred for wastewater treatment.

The outflow from the MAP precipitation unit 16 is subsequently further aerobically treated in the activation process. Two SBR units 17 are here used, which are fed alternately. In addition, the reactors were equipped with precipitation/flocculant dosing stations so that, depending on the measured phosphorus concentration, further phosphorus compounds can be eliminated by way of simultaneous precipitation.

Here, the process stages biological P elimination with or without simultaneous P-precipitation, nitrification and denitrification take place in the same reaction space in consecutive temporal order.

The excess activated sludge is temporarily stored in a sludge buffer tank 3 and thereafter automatically drained and supplied to agricultural use. The clear outflow from the SBR units 17 is discharged into the receiving water via the outflow reservoir 18 and the outflow 19. The aerobic purification stage of the SBR unit 17 was designed so that the required cleaning performance can be attained even if the anaerobic stage fails, for example due to a short-term shut-down for maintenance purposes, or due to a failure of the MAP precipitation unit 16. However, this is associated with a higher expenditures.

Optionally, the clear discharge of the SBR unit 17 is also fed to an additional unillustrated wastewater filtration, where additional organically bound phosphorus is removed. The backwash water of the filtration is returned to the SBR units 17.

Since the effluents from the dairy processing industry are easily microbiologically degradable and consequently tend quickly to form unpleasant odors, the exhaust air from the system components, including the storage and buffer tanks, is cleaned by using a photo ionization process.

### LIST OF REFERENCE SYMBOLS

1 electrodialysis unit; electrodialysis two-way
2 buffer tank; buffer tank 2, V=3026 m³
3 sludge buffer tank; buffer tank 3 (sludge), V=455 m³
4 flotate buffer tank; buffer tank 4 (flotate), V=369 m³
5 concentrate buffer tank; buffer tank 5 (concentrate), V=434 m³
6 cation exchanger; L4 cation exchanger (151 m³d)
6.1 cation exchange buffer tank; buffer tank 1.1, V=300 m³
7 anion exchanger; L5 anion exchanger (119 m³d)
7.1 anion exchange buffer tank; Buffer tank 1.2, V=300 m ³
8 reverse osmosis unit; L6 reverse osmosis (231 m³d)
8.1 reverse osmosis unit buffer tank; buffer tank 1.3, V=300 m³
9 accidental-damage reservoir; accidental-damage reservoir, V=1000 m³
10 denitrification tank; deni tank, V=1000 m³
11 flotation 1, flotation tank
12 flotation 2, flotation tank
13 gas treatment, gas recovery, cogeneration plant
14 anaerobic reactor; anaerobic reactor R2S, one-way, V=471 m³
15 MAP magnesium ammonium phosphate recovery; MAP (recovery)
16 MAP precipitation unit; MAP precipitation (two-way), V=2×290 m³
17 SBR unit; SBR (two-way), V=2×2,475 m³
18 outflow reservoir; outflow reservoir, V=1,000 m³
19 outflow
20 partial wastewater stream, inlet drying plant; L 1/3 drying plant (1097 m^{3/}d)
21 partial wastewater stream, inlet cheese dairy; L2 cheese dairy (700 m^{3/}d)
22 partial wastewater stream, inlet cation exchanger
23 partial wastewater stream, inlet anion exchanger
24 partial wastewater stream, inlet reverse osmosis

1.-14. (canceled)

15. A wastewater treatment arrangement for cleaning of individual partial wastewater streams polluted by different industrial effluents, comprising the following components:
an electrodialysis unit,
an accidental-damage reservoir,
a buffer tank,
said buffer tank is configured to be accessible directly by some of the polluted partial wastewater streams and/or indirectly via the electrodialysis unit, and
said buffer tank is also accessible directly by different polluted partial wastewater flows and/or indirectly via the accidental-damage reservoir, and wherein downstream of said buffer tank, a first flotation tank, an anaerobic reactor and an SBR unit are arranged in series before an outflow.

16. The wastewater treatment arrangement according to claim 15, wherein a denitrification tank with a downstream second flotation tank is arranged in parallel with the accidental-damage reservoir, and wherein the second flotation tank is connected with the accidental-damage reservoir and/or the buffer tank.

17. The wastewater treatment arrangement according to claim 16, wherein a MAP precipitation unit with a MAP magnesium ammonium phosphate recovery is arranged between the anaerobic reactor and the SBR unit.

18. The wastewater treatment arrangement according to claim 15, wherein a concentrate buffer tank is arranged downstream of electrodialysis unit, and/or downstream of the first flotation tank, a flotate buffer tank, and/or downstream of the anaerobic reactor, a gas treatment, gas recovery, cogeneration plant are arranged downstream of electrodialysis unit.

19. The wastewater treatment arrangement according to claim 17, wherein the MAP precipitation unit and/or the SBR unit are configured as two-way units for alternating operation of said units for a quasi-continuous operation.

20. The wastewater treatment arrangement according to claim 19, wherein a sludge buffer tank and/or an outflow reservoir are arranged before the outflow for the clear water and after the SBR unit.

21. The wastewater treatment arrangement according to claim 15, wherein the outflow reservoir is dimensioned such that in normal operation, the wastewater treatment arrangement is filled to only to 50%.

22. The wastewater treatment arrangement according to claim 15, wherein a return pump line into the accidental-damage reservoir is arranged between the outflow reservoir for an eventual accident.

23. A modular method for an efficient cleaning of differently polluted wastewater streams in a wastewater treatment arrangement according to claim 15, wherein a separate measurement of the individual wastewater streams is performed and that the wastewater streams are treated as partial streams separately in a modular manner and are subsequently combined, and undergoing further treatment depending on their properties.

24. The modular method for the efficient purification of differently contaminated wastewater according to claim 23, wherein, depending on the properties of the wastewater partial stream—
a) an electrodialysis takes place to reduce a chloride load by ⅓ and a potassium load by ⅔ relative to the initial value for only a single wastewater partial flow,
b) a flotation of undissolved substances takes place,
c) an anaerobic wastewater treatment for producing biogas as a valuable material from a high-salt substrate takes place,
) a MAP precipitation for the production of magnesium ammonium phosphate as a valuable substance takes place, and that e) an aerobic wastewater treatment in an SBR process takes place with further P elimination in a salt-rich substrate.

25. The method according to claim 23, wherein the treated wastewater stream is filtered before reaching an outflow.

26. The method according to claim 24, wherein an exhaust air treatment and desulfurization of the biogas generated in the anaerobic wastewater treatment takes place.

27. The method according to claim 24, wherein in step b) a dissolved air flotation is performed.

28. The method according to claim 24, wherein depending on measured phosphorus concentrations, additional phosphorus compounds are eliminated by way of simultaneous precipitation.
